(19) United States
(12) Patent Application Publication
(10) Pub. No.: US 2026/0257282 A1
(43) Pub. Date: Sep. 3, 2026

(54) CUTTING TOOL, AND METHOD FOR MANUFACTURING MACHINED PRODUCT

(71) Applicant: KYOCERA CORPORATION, Kyoto (JP)

(72) Inventor: Shigetaka HASHIMOTO, Kyoto (JP)

(21) Appl. No.: 18/995,765

(22) PCT Filed: Jul. 14, 2023
(86) PCT No.: PCT/JP2023/026100

§ 371 Date: Jan. 16, 2025

(30) Foreign Application Priority Data
Jul. 25, 2022 (JP) 2022-118229

(51) Int. Cl. B23B 29/12

(52) U.S. Cl. CPC B23B 29/12; B23B 2260/1285

(57) ABSTRACT

A cutting tool comprises a holder, a cutting insert and a sensor unit. The holder has a rod shape and comprises a front end surface, an upper surface, a lower surface, a first side surface, a second side surface and a pocket. A cutting insert is located in the pocket and comprises a cutting edge. A sensor unit comprises a unit base, a first sensor and a second sensor. The unit base is located from the lower surface to the second side surface, and the unit base has an L shape in a cross section orthogonal to the longitudinal direction of the holder. The first sensor located in a first recessed portion of the unit base comes into contact with the lower surface. The second sensor located in a second recessed portion of the unit base comes into contact with the second side surface.

### TECHNICAL FIELD

The present disclosure relates to a cutting tool used in machining of a workpiece, and a method for manufacturing a machined product.

### BACKGROUND OF INVENTION

For example, a cutting tool described in Patent Document 1 is known as a cutting tool used in machining of a workpiece for manufacturing a machined product. The cutting tool described in Patent Document 1 includes a sensor portion for detecting a physical quantity (referred to as physical information in Patent Document 1) of a cutting insert (referred to as a cutting edge in Patent Document 1). Wear, temperature, pressure and vibration of the cutting insert are exemplified as the physical quantities, and a cutting tool provided with a temperature sensor is disclosed as an example.

### CITATION LIST

### Patent Literature

Patent Document 1: JP 2012-020359 A

### SUMMARY

A cutting tool according to the present disclosure includes a holder, a cutting insert, and a sensor unit. The holder has a rod shape extending from a front end toward a rear end and includes a front end surface located on a side of the front end, an upper surface extending from the front end surface toward the rear end, a lower surface located on an opposite side to the upper surface, a first side surface located between the upper surface and the lower surface and extending from the front end surface toward the rear end; a second side surface located on an opposite side to the first side surface; and a pocket open to the front end surface, the upper surface, and the first side surface. The cutting insert is located in the pocket and includes a cutting edge. The sensor unit includes a unit base, a first sensor, and a second sensor. The unit base is located from the lower surface to the second side surface, includes a first recessed portion open toward the lower surface and a second recessed portion open toward the second side surface, and has an L shape in a cross section orthogonal to the longitudinal direction of the holder. The first sensor is located in the first recessed portion, is in contact with the lower surface, and detects a physical quantity of the holder (cutting tool). The second sensor is located in the second recessed portion, is in contact with the second side surface, and detects a physical quantity of the holder (cutting tool) in a detection direction orthogonal to a detection direction of the first sensor.

### BRIEF DESCRIPTION OF THE DRAWINGS

FIG. 1 is a schematic perspective view of a cutting tool according to an embodiment of the present disclosure.

FIG. 2 is a schematic perspective view of the cutting tool illustrated in FIG. 1 viewed at a different angle.

FIG. 3 is a schematic plan view of the cutting tool illustrated in FIG. 1.

FIG. 4 is a schematic view of the cutting tool illustrated in FIG. 1, as viewed from a front end side of the cutting tool.

FIG. 5 is a schematic side view of the cutting tool illustrated in FIG. 1.

FIG. 6 is an enlarged schematic view of another side surface of the cutting tool illustrated in FIG. 5.

FIG. 7 is a cross-sectional view taken along line VII-VII in FIG. 5.

FIG. 8 is a cross-sectional view taken along line VIII-VIII in FIG. 5.

FIG. 9 is a cross-sectional view taken along line IX-IX in FIG. 5.

FIG. 10 is a schematic perspective view of a cutting tool according to another embodiment of the present disclosure.

FIG. 11 is a schematic side view of the cutting tool illustrated in FIG. 10.

FIG. 12 is a schematic perspective view of a cutting tool according to another embodiment of the present disclosure.

FIG. 13 is a schematic view of the cutting tool illustrated in FIG. 12, as viewed from a front end side of the cutting tool.

FIG. 14 is a schematic view illustrating a method for manufacturing a machined product according to an embodiment of the present disclosure.

FIG. 15 is a schematic view illustrating the method for manufacturing the machined product according to the embodiment of the present disclosure.

FIG. 16 is a schematic view illustrating the method for manufacturing the machined product according to the embodiment of the present disclosure.

### DESCRIPTION OF EMBODIMENTS

In the cutting tool described in Patent Document 1, since the sensor portion is attached in the vicinity of the cutting edge of the cutting insert, the sensor portion may fall off from the cutting insert during machining of a workpiece.

In order to avoid falling of the sensor portion, incorporating the sensor portion in the holder of the cutting tool is conceivable. When the sensor portion is a temperature sensor, since the sensor portion is small, the strength of the holder is less likely to be reduced significantly. However, when the sensor unit is a pressure sensor or a vibration sensor, a decrease in strength (rigidity) of the holder due to the incorporated sensor portion cannot be neglected.

In particular, during machining, cutting loads in three directions of a main component force, a thrust component force, and a feed component force are applied to the cutting tool. In order to ensure high detection accuracy of the sensor portion, when physical quantities such as acceleration in three directions corresponding to these three cutting loads are to be detected, the sensor portion needs to have a plurality of sensors corresponding to the three directions. If such a space for incorporating the sensor portion is provided in the holder, this may complicate the processing of the holder and may lead to a decrease in the durability of the holder.

According to the present disclosure, durability of the holder can be enhanced while ensuring high detection accuracy of the sensor unit.

A cutting tool, and a method for manufacturing a machined product according to an embodiment of the present disclosure will be described below in detail with reference to the drawings. However, each of the drawings, which will be referred to below, is a simplified representation of only components necessary for description of the embodiment, for convenience of description. Accordingly, the cutting insert according to an embodiment of the present disclosure may be provided with an optional component that is not illustrated in the referenced drawings. The dimensions of the components in the drawings do not faithfully represent the actual dimensions of the components, the dimension ratios of the members, or the like.

In the present disclosure, description will be made based on an orthogonal coordinate system XYZ defined by three directions orthogonal to each other. The X direction is a front-rear direction, one side in the X direction is a front side or a front direction, and the other side in the X direction is a rear side or a rear direction. The Y direction is a left-right direction, one side in the Y direction is a left side or a left direction, and the other side in the Y direction is a right side or a right direction. The Z direction is a vertical direction, one side in the Z direction is an upper side or an upward direction, and the other side in the Z direction is a lower side or a downward direction. The XY direction refers to two directions of the X direction and the Y direction, the XZ direction refers to two directions of the X direction and the Z direction, and the YZ direction refers to two directions of the Y direction and the Z direction. The XYZ direction refers to three directions of the X direction, the Y direction, and the Z direction.

In the drawings, “FF” indicates the front direction, “FR” indicates the rear direction, “L” indicates the left direction, “R” indicates the right direction, “U” indicates the upward direction, and “D” indicates the downward direction.

### Cutting Tool

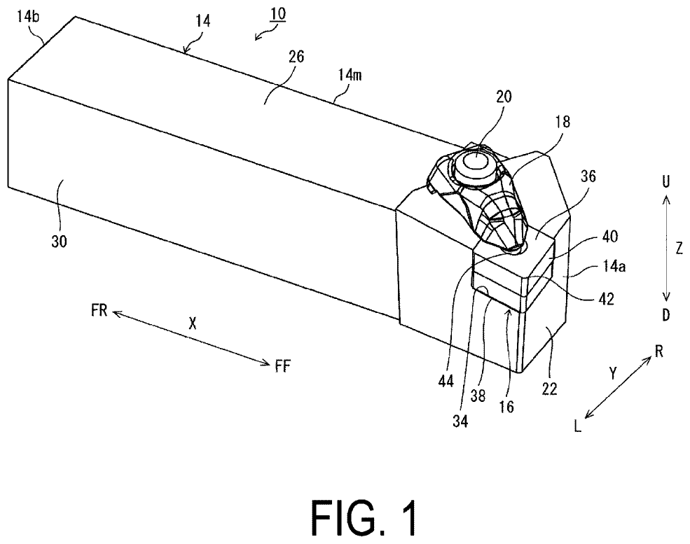

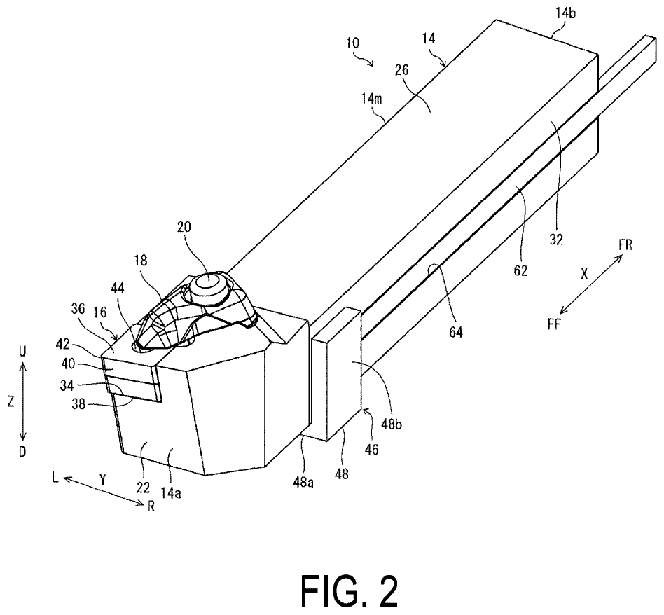

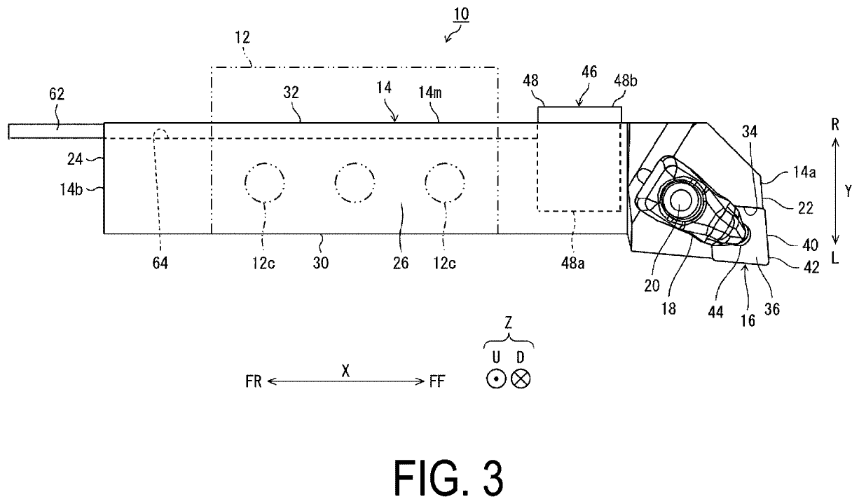

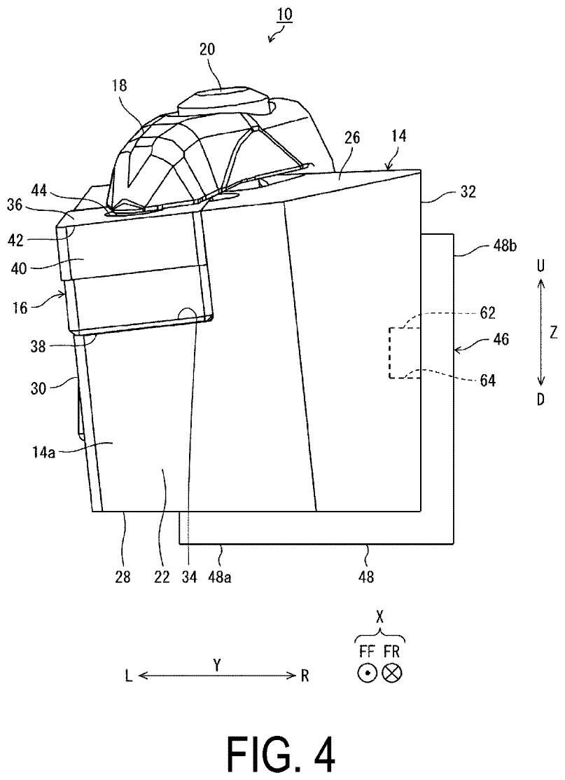

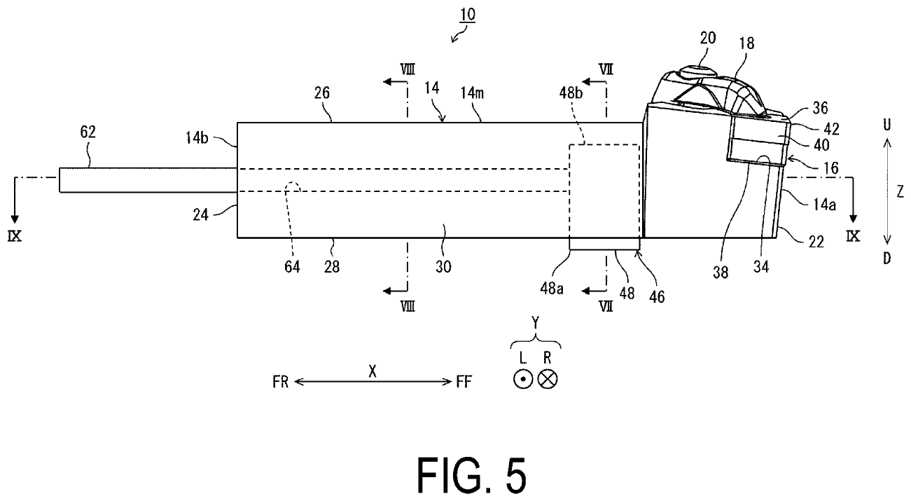

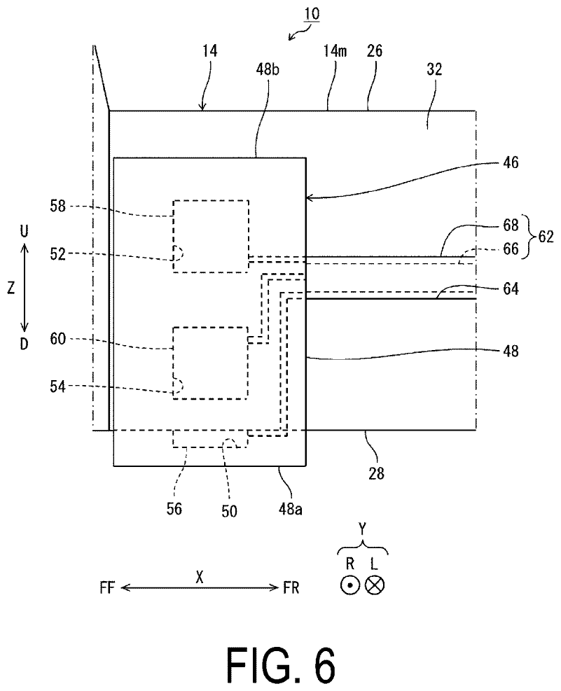

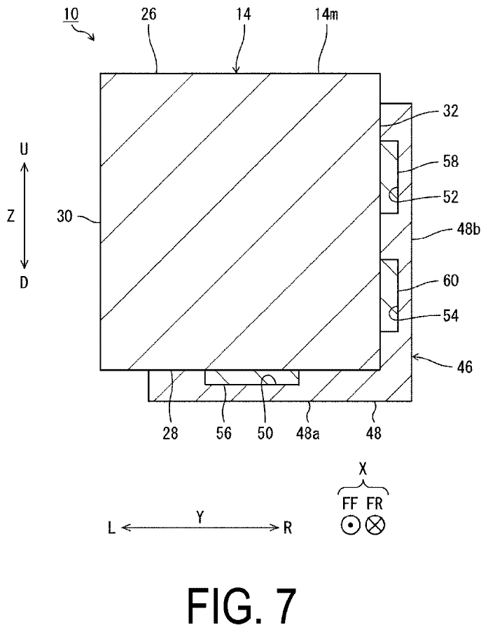

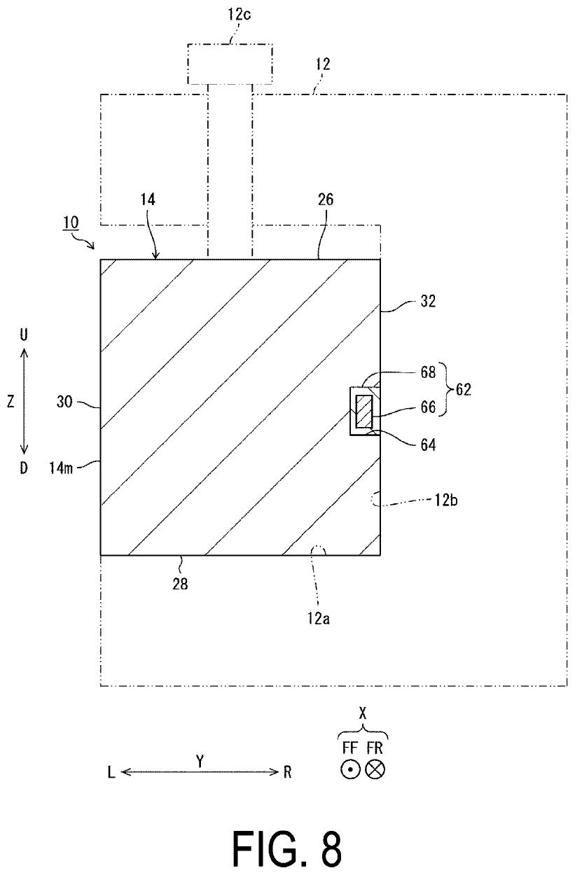

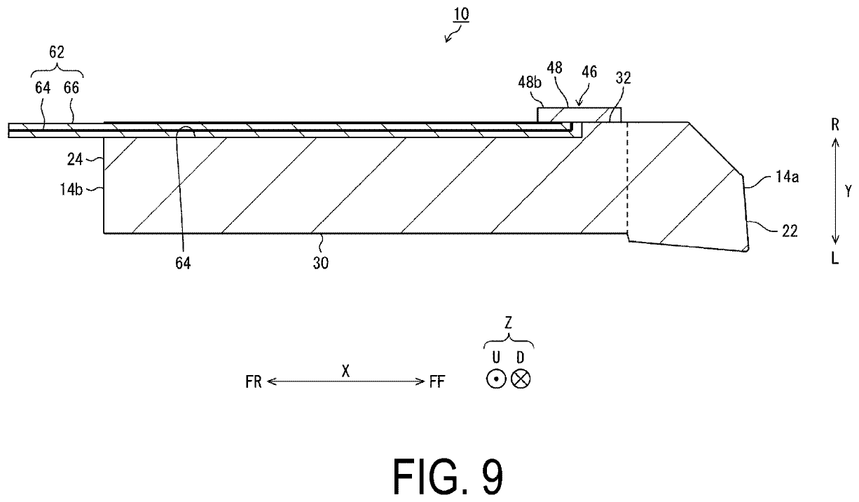

A cutting tool 10 according to an embodiment of the present disclosure will be described with reference to FIGS. 1 to 9. FIG. 1 is a schematic perspective view of the cutting tool 10 according to the embodiment of the present disclosure. FIG. 2 is a schematic perspective view of the cutting tool illustrated in FIG. 1 viewed at a different angle. FIG. 3 is a schematic plan view of the cutting tool 10 illustrated in FIG. 1. FIG. 4 is a schematic view of the cutting tool 10 illustrated in FIG. 1 viewed from the front end side thereof. FIG. 5 is a schematic side view of the cutting tool 10 illustrated in FIG. 1. FIG. 6 is an enlarged side view of the vicinity of a sensor unit when viewed from the opposite side of FIG. 5. FIG. 7 is a cross-sectional view taken along line VII-VII in FIG. 5. FIG. 8 is a cross-sectional view taken along line VIII-VIII in FIG. 5. FIG. 9 is a cross-sectional view taken along line IX-IX in FIG. 5.

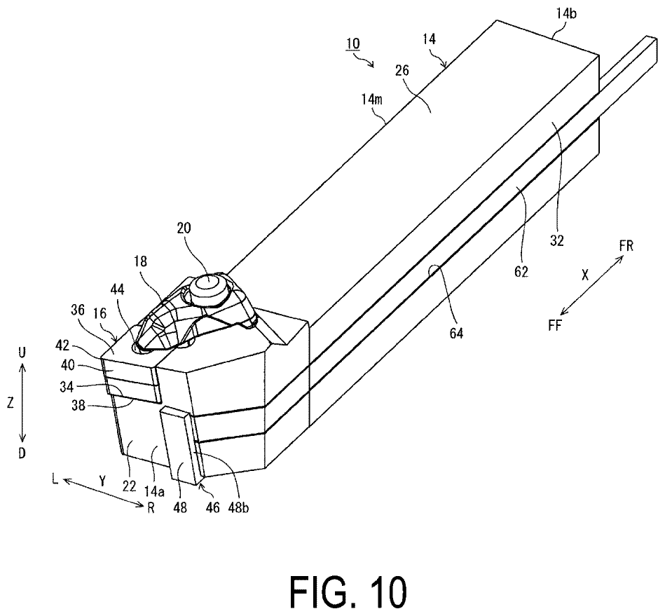

As the example illustrated in FIGS. 1 to 3, the cutting tool 10 according to the embodiment of the present disclosure is a tool used for machining of a workpiece W (see FIG. 10). The machining of the workpiece W includes external turning, boring, groove-forming, and cutting-off. The cutting tool 10 may include a holder 14 mounted on a cutting implement rest 12 of a lathe, a cutting insert 16 held by the holder 14, a clamp 18 fixing the cutting insert 16 to the holder 14, and a clamping screw 20 for attaching the clamp 18 to the holder 14.

As in the example illustrated in FIGS. 1 to 5, the holder 14 may have a rod shape extending along the X direction from a front end 14a toward a rear end 14b. The longitudinal direction of the holder 14 may be the X direction. The holder 14 may include a quadrangular prism-shaped body portion 14m located closer to the rear end 14b side than the clamp 18.

As an example illustrated in FIGS. 1 to 5, the holder 14 may include a front end surface 22 located on the front end 14a side and a rear end surface 24 located on the opposite side to the front end surface 22. The holder 14 may include an upper surface 26 extending in the X direction from the front end surface 22 toward the rear end 14b to the rear end surface 24. The holder 14 may include a lower surface 28 located on the opposite side to the upper surface 26, and the lower surface 28 may extend in the X direction from the front end surface 22 toward the rear end 14b to the rear end surface 24.

The holder 14 may include a first side surface 30 located between the upper surface 26 and the lower surface 28, and the first side surface 30 may extend in the X direction from the front end surface 22 toward the rear end 14b to the rear end surface 24. The first side surface 30 of the holder 14 may be connected to the upper surface 26 and the lower surface 28. In the body portion 14m of the holder 14, the first side surface 30 may be orthogonal to the lower surface 28 and the upper surface 26.

The holder 14 may include a second side surface 32 located on the opposite side to the first side surface 30, and the second side surface 32 may extend in the X direction from the front end surface 22 toward the rear end 14b to the rear end surface 24. The second side surface 32 of the holder 14 may be connected to the upper surface 26 and the lower surface 28. In the body portion 14m of the holder 14, the second side surface 32 may be orthogonal to the lower surface 28 and the upper surface 26.

The front end surface 22, the rear end surface 24, the upper surface 26, the lower surface 28, the first side surface 30, and the second side surface 32 of the holder 14 may constitute outer surfaces of the holder 14. The holder 14 may include a pocket 34 for holding the cutting insert 16 on the front end 14a side. The pocket 34 may be open to the front end surface 22, the upper surface 26, and the first side surface 30.

When the cutting tool 10 is mounted on the cutting implement rest 12, the lower surface 28 of the body portion 14m of the holder 14 is supported by a placement surface 12a (see FIG. 8) of the cutting implement rest 12. The second side surface 32 of the body portion 14m of the holder 14 is supported by an inner wall surface 12b (see FIG. 8) of the cutting implement rest 12. The upper surface 26 of the body portion 14m of the holder 14 is pressed by a fixing screw 12c (see FIG. 8) of the cutting implement rest 12.

Examples of the material of the holder 14 include metals such as stainless steel, carbon steel, cast iron, and an aluminum alloy. The length of the holder 14 may be set to, for example, from 100 mm to 400 mm.

As in the examples illustrated in FIG. 1 to FIG. 5, the cutting insert 16 may be located in the pocket 34 of the holder 14. The cutting insert 16 may be a replaceable insert called a throw-away insert. The cutting insert 16 may have a quadrangular plate shape, or may have a triangular plate shape or a pentagonal plate shape other than the quadrangular plate shape. The cutting insert 16 may include a first insert surface 36, a second insert surface 38 located on the opposite side to the first insert surface 36, and a plurality of insert side surfaces 40 located between the first insert surface 36 and the second insert surface 38.

The cutting insert 16 may include a cutting edge 42 at the intersection of the first insert surface 36 and the insert side surface 40. The first insert surface 36 may function as a rake surface for channeling chips. The insert side surface 40 may function as a flank surface.

The cutting insert 16 may include a through hole 44 that is open to the first insert surface 36 and the second insert surface 38. The cutting insert 16 is attached to the pocket 34 by tightening the clamping screw 20 in a state where the front end portion of the clamp 18 is engaged with the through hole 44.

Examples of the material of the cutting insert 16 include a cemented carbide alloy and a cermet. Examples of the composition of the cemented carbide alloy include WC—Co, WC—TiC—Co, and WC—TiC—TaC—Co. WC—Co is produced by adding a cobalt (Co) powder to tungsten carbide (WC) and sintering them. WC—TiC—Co is formed by adding titanium carbide (TiC) to WC—Co. WC—TiC—TaC—Co is formed by adding tantalum carbide (TaC) to WC—TiC—Co. Cermet is a sintered composite material in which a metal is combined with a ceramic component. Specifically, examples of the cermet include compounds in which a titanium compound such as titanium carbide (TiC) or titanium nitride (TiN) is the primary component.

The surface of the cutting insert 16 may be coated with a coating film using a chemical vapor deposition (CVD) method or a physical vapor deposition (PVD) method. Examples of the material of the coating film include titanium carbide (TiC), titanium nitride (TiN), titanium carbonitride (TiCN), and alumina (Al₂O₃).

As in the examples illustrated in FIGS. 2 to 7, the cutting tool 10 may include a sensor unit 46 for detecting a physical quantity such as the acceleration, vibration, strain, or internal stress of the holder 14 (cutting tool 10). The sensor unit 46 may include a unit base 48 located from the lower surface 28 to the second side surface 32 of the body portion 14m of the holder 14. A unit base 48 may be attached to the body portion 14m of the holder 14 by an adhesive. The unit base 48 may be attached to the body portion 14m of the holder 14 by magnetic force of a built-in magnet. The unit base 48 may be attached to the body portion 14m of the holder 14 by a fixing member such as a screw. Examples of the material of the unit base 48 include synthetic resin and metal.

As in the example illustrated in FIGS. 4 and 7, the unit base 48 may have an L shape in a cross section orthogonal to the X direction which is the longitudinal direction of the holder 14. In other words, the sensor unit 46 may have an L shape in a cross section orthogonal to the X direction. The unit base 48 may include a first portion 48a located on the lower surface 28 of the holder 14 and a second portion 48b located on the second side surface 32 of the holder 14. The distance in the X direction from the unit base 48 to the front end surface 22 of the holder 14 may be shorter than the distance in the X direction from the unit base 48 to the rear end surface 24 of the holder 14.

As in the example illustrated in FIG. 4, the entirety of the first portion 48a of the unit base 48 may be located closer to the second side surface 32 than to the first side surface 30 of the holder 14. The entirety of the second portion 48b of the unit base 48 may be located closer to the lower surface 28 than to the upper surface 26 of the holder 14.

As in the example illustrated in FIGS. 6 and 7, the first portion 48a of the unit base 48 may include a first recessed portion 50 that is open toward the lower surface 28 of the holder 14. The first recessed portion 50 of the unit base 48 may be a bottomed hole (depression) or a through hole. When the first recessed portion 50 of the unit base 48 is a bottomed hole, waterproof performance with respect to the first sensor 56 and the like is easily enhanced. The second portion 48b of the unit base 48 may include a second recessed portion 52 that is open toward the second side surface 32 of the holder 14. The second recessed portion 52 of the unit base 48 may be a bottomed hole or a through hole.

The unit base 48 may further include another recessed portion in addition to the first recessed portion 50 and the second recessed portion 52. For example, the first portion 48a of the unit base 48 may further include a recessed portion that is open toward the lower surface 28 of the holder 14 in addition to the second recessed portion 52. As in the example illustrated in FIGS. 6 and 7, the second portion 48b of the unit base 48 may include a third recessed portion 54 that is open toward the second side surface 32 of the holder 14. The third recessed portion 54 of the unit base 48 may be a bottomed hole or a through hole. The first recessed portion 50, the second recessed portion 52, and the third recessed portion 54 in the unit base 48 may be independent from each other or may be continuous with each other. For example, the first recessed portion 50 of the unit base 48 may be independent from the second recessed portion 52 and the third recessed portion 54, and the third recessed portion 54 of the unit base 48 may be continuous with the second recessed portion 52.

The sensor unit 46 may include a first sensor 56 located within the first recessed portion 50 of the unit base 48. The first sensor 56 may be fixed in the first recessed portion 50 of the unit base 48 by an adhesive or the like. The first sensor 56 may detect any one or more of physical quantities such as the acceleration, vibration, strain, and internal stress of the holder 14. The detection direction of the first sensor 56 may be the Y direction. In other words, the first sensor 56 may detect a physical quantity such as the acceleration, vibration, strain, or internal stress of the holder 14 in the Y direction. The first sensor 56 may detect the acceleration or the like of the holder 14 corresponding to the feed component force. The first sensor 56 may come into contact with the lower surface 28 of the holder 14. When the first sensor 56 is in contact with the lower surface 28 of the holder 14, the accuracy of the detection of the physical quantities described above is improved.

The sensor unit 46 may include a second sensor 58 located in the second recessed portion 52 of the unit base 48. The second sensor 58 may be fixed in the second recessed portion 52 of the unit base 48 by an adhesive or the like. The position of the second sensor 58 in the X direction may be the same as the position of the first sensor 56 in the X direction. In other words, the position of the center of the second sensor 58 in the X direction may be within a range of ±1 mm with respect to the position of the center of the first sensor 56 in the X direction. The second sensor 58 may come into contact with the second side surface 32 of the holder 14. The second sensor 58 may come into contact with the second side surface 32 of the holder 14. When the second sensor 58 is in contact with the second side surface 32 of the holder 14, the accuracy of the detection of the physical quantities described above is improved.

The second sensor 58 may come into contact with the second side surface 32 of the holder 14. The second sensor 58 may detect any one or more of physical quantities such as the acceleration, vibration, strain, and internal stress of the holder 14. The second sensor 58 may detect the same physical quantity as the first sensor 56. The detection direction of the second sensor 58 may be the X-direction orthogonal to the detection direction of the first sensor 56. In other words, the second sensor 58 may detect a physical quantity such as the acceleration, vibration, strain, or internal stress of the holder 14 in the X direction. The second sensor 58 may detect the acceleration or the like of the holder 14 corresponding to the thrust component force.

The cutting tool 10 of the present disclosure does not have a configuration in which sensors such as the first sensor 56 and the second sensor 58 are embedded in the holder 14, but has a configuration in which the sensor unit 46 that is a separate body from the holder 14 includes a sensor. Therefore, performing complicated processing for embedding the sensor inside the holder 14 is not necessary, and the existing holder 14 can be easily utilized.

The sensor unit 46 may include a third sensor 60 located in the third recessed portion 54 of the unit base 48. The third sensor 60 may be fixed in the third recessed portion 54 of the unit base 48 by an adhesive or the like. The third sensor 60 may come into contact with the second side surface 32 of the holder 14. The position of the third sensor 60 in the X direction may be the same as the position of the second sensor 58 in the X direction. In other words, the position of the center of the third sensor 60 in the X direction may be within a range of ±1 mm with respect to the position of the center of the second sensor 58 in the X direction.

The third sensor 60 may detect any one or more of physical quantities such as the acceleration, vibration, strain, and internal stress of the holder 14. The third sensor 60 may detect the same physical quantity as the first sensor 56 and the second sensor 58. The detection direction of the third sensor 60 may be the Z direction orthogonal to the detection directions of the first sensor 56 and the second sensor 58. In other words, the third sensor 60 may detect a physical quantity such as the acceleration, vibration, strain, or internal stress of the holder 14 in the Z direction. The third sensor 60 may detect the acceleration or the like of the holder 14 corresponding to the main component force.

The first sensor 56, the second sensor 58, and the third sensor 60 may detect physical quantities such as the acceleration, vibration, strain, and internal stress of the holder 14 in the XYZ directions. The first sensor 56, the second sensor 58, and the third sensor 60 may detect the acceleration or the like of the holder 14 corresponding to cutting loads in three directions (main component force, thrust component force, and feed component force).

The positions of the first sensor 56, the second sensor 58, and the third sensor 60 in the X direction may be the same. The first sensor 56, the second sensor 58, and the third sensor 60 may be electrostatic capacitance detection sensors or piezoresistive sensors. The first sensor 56, the second sensor 58, and the third sensor 60 are the electrostatic capacitance detection sensors, the sensors may be Micro Electro Mechanical Systems (MEMS).

The detection direction of the first sensor 56 may be changed from the Y direction to the XY direction. The first sensor 56 may detect a physical quantity such as the acceleration, vibration, strain, or internal stress of the holder 14 in the XY direction. The first sensor 56 may detect the acceleration or the like of the holder 14 corresponding to the feed component force and the main component force. In these cases, one of the second sensor 58 and the third sensor 60 may be omitted from the components of the sensor unit 46.

The detection direction of the second sensor 58 may be changed from the X direction to the XZ direction. The second sensor 58 may detect a physical quantity such as the acceleration, vibration, strain, or internal stress of the holder 14 in the XZ direction. The second sensor 58 may detect the acceleration or the like of the holder 14 corresponding to the thrust component force and the main component force. In this case, the third sensor 60 may be omitted from the components of the sensor unit 46.

The detection direction of the third sensor 60 may be changed from the Z direction to the XZ direction. The third sensor 60 may detect a physical quantity such as the acceleration, vibration, strain, or internal stress of the holder 14 in the XZ direction. The third sensor 60 may detect the acceleration or the like of the holder 14 corresponding to the main component force and the thrust component force. In this case, the second sensor 58 may be omitted from the components of the sensor unit 46.

As in the examples illustrated in FIGS. 2, 5, 6, 8, and 9, the cutting tool 10 may include a wiring member 62 electrically connected to the first sensor 56, the second sensor 58, and the third sensor 60. The wiring member 62 may extend in the X direction from the side of the first sensor 56 or the like toward the rear end 14b of the holder 14.

The holder 14 may include a groove 64 extending in the X direction from the side of the first sensor 56 or the like toward the rear end 14b of the holder 14. The groove 64 of the holder 14 may be open to the second side surface 32. The groove 64 of the holder 14 may be open to the lower surface 28. The groove 64 of the holder 14 may be open to the lower surface 28 and the second side surface 32.

As in the example illustrated in FIGS. 6, 8, and 9, the wiring member 62 may be located in the groove 64 of the holder 14. In other words, the groove 64 of the holder 14 may accommodate the wiring member 62. The wiring member 62 may include a wiring conductor 66 electrically connected to the first sensor 56, the second sensor 58, and the third sensor 60. The wiring conductor 66 may extend in the X direction from the side of the first sensor 56 or the like toward the rear end 14b of the holder 14. The wiring member 62 may include a tubular holding member 68 that holds the wiring conductor 66. The holding member 68 may be located in the groove 64 of the holder 14. In other words, the groove 64 of the holder 14 may accommodate the holding member 68. The material of the holding member 68 may be the same as that of the holder 14.

The wiring member 62 may be electrically connected to an information processing device installed outside a machine tool or the like. The information processing device may be configured by a computer, and may include a memory that stores various control programs and the like and a central processing unit (CPU) that interprets and executes the control programs.

When the control program is executed by the CPU, the information processing device exhibits various functions. In one aspect, the information processing device may adjust the moving speed of the cutting tool 10 based on the physical quantities of the holder 14 detected by the first sensor 56, the second sensor 58, and the third sensor 60. In one aspect, the information processing device may adjust the rotational speed of the workpiece W based on the physical quantities of the holder 14 detected by the first sensor 56, the second sensor 58, and the third sensor 60.

According to an example of the embodiment of the present disclosure, at least two of the first sensor 56, the second sensor 58, and the third sensor 60 can detect physical quantities such as the acceleration, vibration, strain, and internal stress of the holder 14 in the XYZ directions. At least two of the first sensor 56, the second sensor 58, and the third sensor 60 can detect the acceleration or the like of the holder 14 corresponding to cutting loads in three directions (main component force, thrust component force, and feed component force). Therefore, according to an example of the embodiment of the present disclosure, high detection accuracy of the sensor unit 46 can be ensured.

When the first sensor 56, the second sensor 58, and the third sensor 60 detect physical quantities such as the acceleration of the holder 14 in the XYZ directions, the detection accuracy of the sensor unit 46 can be enhanced. In particular, when the position of the third sensor 60 in the X direction is the same as the position of the second sensor 58 in the X direction, the detection accuracy of the sensor unit 46 can be further enhanced.

When the distance in the X direction from the unit base 48 to the front end surface 22 of the holder 14 is shorter than the distance in the X direction from the unit base 48 to the rear end surface 24 of the holder 14, the sensor unit 46 is positioned closer to the front end surface 22 of the holder 14 where a change in physical quantity such as acceleration is significant. Therefore, according to an example of the embodiment of the present disclosure, since the sensor unit 46 is close to the machining point, a slight change in physical quantity can be captured, and thus enhancing the detection accuracy of the sensor unit 46.

According to an example of an embodiment of the present disclosure, the unit base 48 is located from the lower surface 28 to the second side surface 32 of the body portion 14m of the holder 14, which is an orthogonal region on the outer surface of the holder 14. The unit base 48 has an L shape in a cross section orthogonal to the X direction which is the longitudinal direction of the holder 14. Therefore, the unit base 48 can be attached to the outer surface of the holder 14 without performing processing such as boring on the holder 14. Thus, according to an example of the embodiment of the present disclosure, the durability (rigidity) of the holder 14 can be enhanced.

According to an example of the embodiment of the present disclosure, since the unit base 48 has an L shape in the cross section orthogonal to the X direction, the amount of protrusion of the sensor unit 46 with respect to the outer surface of the holder 14 can be reduced as compared with when a cubic unit base is attached to the outer surface of the holder 14. Thus, according to an example of the embodiment of the present disclosure, the sensor unit 46 is less likely to be affected by chips, the durability of the sensor unit 46 is increased, and also attachment of the cutting tool 10 to the cutting implement rest 12 is simplified.

According to the example of the embodiment of the present disclosure, since the unit base 48 is attached to the holder 14 from two directions of the lower surface 28 and the second side surface 32 of the holder 14, the unit base 48 is unlikely to fall off from the holder 14. Not only the unit base 48 is less likely to fall off from the holder 14 but also the unit base 48 is less likely to be displaced with respect to the holder 14.

When the entirety of the first portion 48a of the unit base 48 is located closer to the second side surface 32 than to the first side surface 30 of the holder 14, the sensor unit 46 does not protrude from the first side surface 30 of the holder 14 in the Y direction. Therefore, according to an example of the embodiment of the present disclosure, the sensor unit 46 is less likely to be affected by chips, and the durability of the sensor unit 46 can be enhanced.

When the entirety of the second portion 48b of the unit base 48 is located closer to the lower surface 28 than to the upper surface 26 of the holder 14, the sensor unit 46 does not protrude in the Z direction from the upper surface 26 of the holder 14. Therefore, according to an example of the embodiment of the present disclosure, the sensor unit 46 is less likely to be affected by chips, and the durability of the sensor unit 46 can be enhanced.

According to an example of the embodiment of the present disclosure, the detection directions of the first sensor 56, the second sensor 58, and the third sensor 60 are one or two of the XYZ directions. In other words, the first sensor 56, the second sensor 58, and the third sensor 60 are single-axis sensors or dual-axis sensors. Therefore, the size of each sensor can be reduced and the sensor unit 46 can be made compact compared to the case of using a three-axis sensor in which the detection directions are three directions of the XYZ directions.

As described above, the unit base 48 is located from the lower surface 28 to the second side surface 32 of the body portion 14m of the holder 14; however, it may be configured as follows.

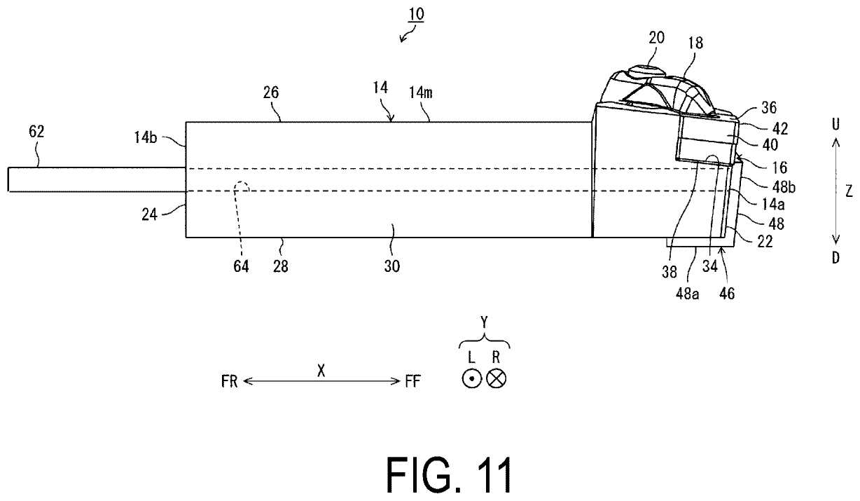

As in the example illustrated in FIGS. 10 and 11, the unit base 48 may be located from the lower surface 28 to the front end surface 22 of the holder 14.

In this case, the unit base 48 may include the first portion 48a located on the lower surface 28 of the holder 14 and the second portion 48b located on the front end surface 22 of the holder 14. The first portion 48a of the unit base 48 may include a first recessed portion that is open toward the lower surface 28 of the holder 14. The second portion 48b of the unit base 48 may include a second recessed portion that is open toward the front end surface 22 of the holder 14. The second portion of the unit base 48 may include a third recessed portion that is open toward the front end surface 22 of the holder 14. The first sensor located in the first recessed portion of the unit base 48 may come into contact with the lower surface 28 of the holder 14. The second sensor located in the second recessed portion of the unit base 48 may come into contact with the front end surface 22 of the holder 14. The third sensor located in the third recessed portion of the unit base 48 may come into contact with the front end surface 22 of the holder 14.

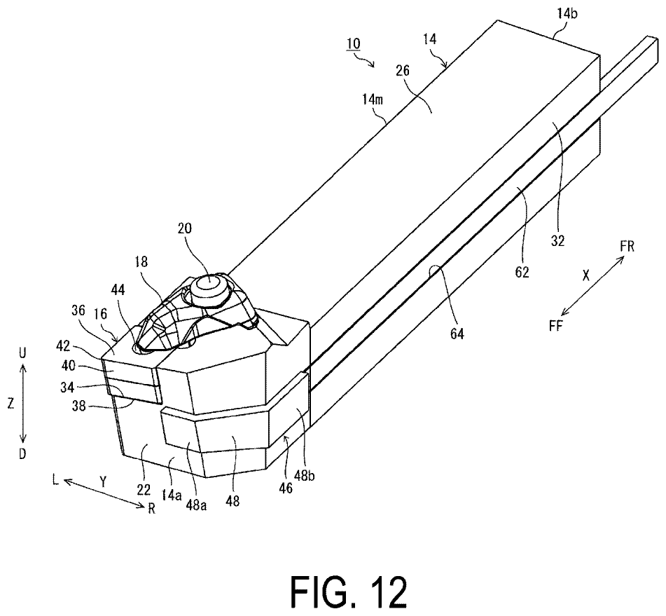

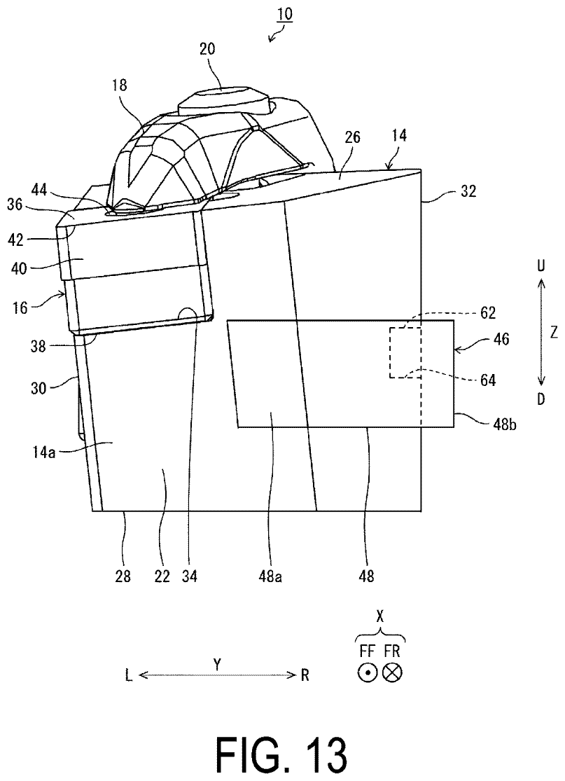

As in the example illustrated in FIGS. 12 and 13, the unit base 48 may be located from the front end surface 22 to the second side surface 32 of the holder 14.

In this case, the unit base 48 may include the first portion 48a located on the front end surface 22 of the holder 14 and the second portion 48b located on the second side surface 32 of the holder 14. The first portion 48a of the unit base 48 may include a first recessed portion that is open toward the front end surface 22 of the holder 14. The second portion 48b of the unit base 48 may include a second recessed portion that is open toward the second side surface 32 of the holder 14. The second portion of the unit base 48 may include a third recessed portion that is open toward the second side surface 32 of the holder 14. The first sensor located in the first recessed portion of the unit base 48 may come into contact with the front end surface 22 of the holder 14. The second sensor located in the second recessed portion of the unit base 48 may come into contact with the second side surface 32 of the holder 14. The third sensor located in the third recessed portion of the unit base 48 may come into contact with the second side surface 32 of the holder 14.

In the above two cases, the sensor unit 46 is located close to the cutting edge 42 of the cutting insert 16, and thus the physical quantity of the holder 14 (cutting tool 10) can be detected with high accuracy. On the other hand, the cutting tool 10 of the example illustrated in FIGS. 1 to 9 can be located away from the machined surface of the workpiece W as compared with the cutting tool 10 of the example illustrated in FIGS. 10 to 13. Therefore, the sensor unit 46 is less likely to come into contact with the machined surface of the workpiece W.

### Method for Manufacturing Machined Product

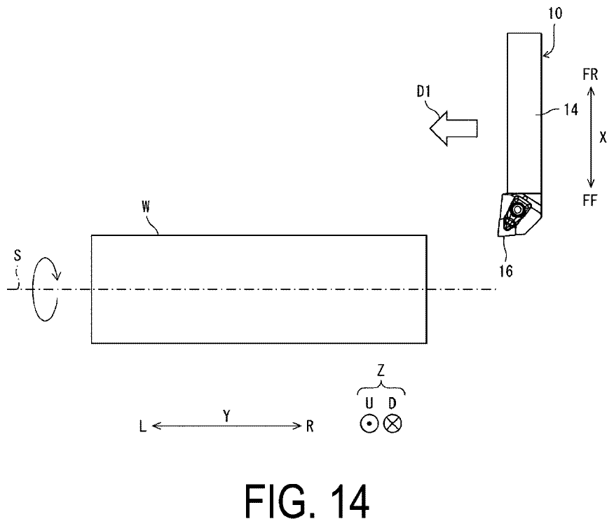

A description will be given of a method for manufacturing a machined product according to an embodiment of the present disclosure with reference to FIGS. 14 to 16. FIGS. 14 to 16 are schematic views illustrating the method for manufacturing the machined product according to the embodiment of the present disclosure.

As in the example illustrated in FIGS. 14 to 16, the method for manufacturing the machined product according to the embodiment of the present disclosure is a method for manufacturing a machined product M, which is the workpiece W after machined, and includes a first step, a second step, and a third step. The first step is a step of rotating the workpiece W about its axis S. The second step is a step of bringing the cutting insert 16 of the cutting tool 10 into contact with the rotating workpiece W and cutting the workpiece W. The third step is a step of separating the cutting tool 10 from the cut workpiece W. Examples of the material of the workpiece W include stainless steel, carbon steel, alloy steel, cast iron, and a non-ferrous metal. The specific content of the method for manufacturing the machined product according to the embodiment is as follows.

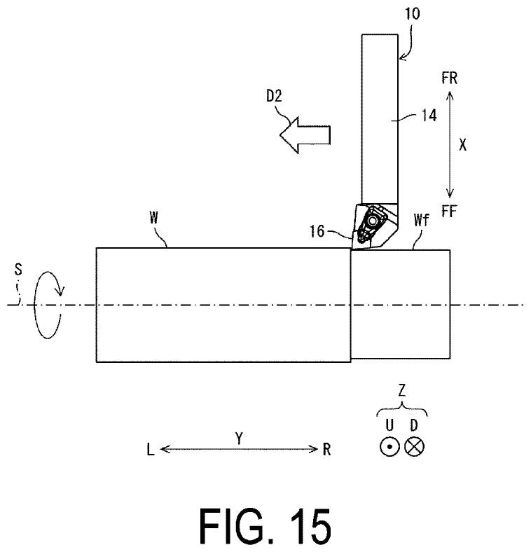

First, the cutting tool 10 is attached to the cutting implement rest 12, and the workpiece W is mounted to a chuck of a lathe. Then, as in the example illustrated in FIG. 14, the chuck is rotated to rotate the workpiece W about its axis S (first step). As in the example illustrated in FIG. 15, the cutting tool 10 is moved in the direction of an arrow D1 to approach the workpiece W, and the cutting insert 16 is brought into contact with the rotating workpiece W and the workpiece W is cut (second step). Thus, a machined surface Wf can be formed on the workpiece W.

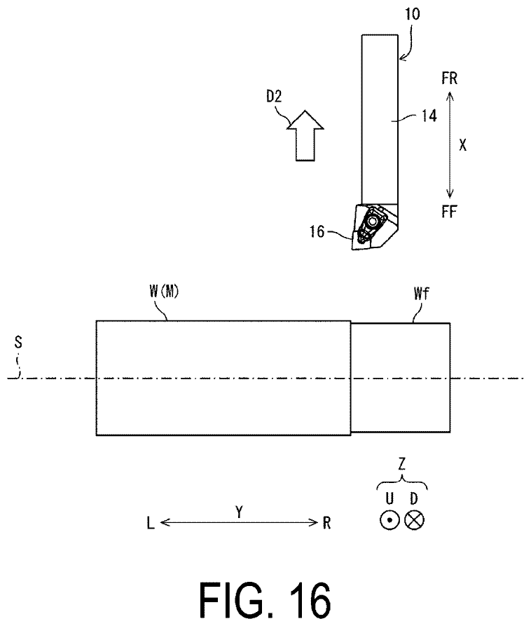

Then, as in the example illustrated in FIG. 16, the cutting tool 10 is moved in the direction of an arrow D2, whereby the cutting tool 10 is moved away from the workpiece W (third step). This completes the machining of the workpiece W and enables the machined product M, which is the workpiece W after the machining, to be manufactured. Since the cutting tool 10 has excellent cutting capabilities because of the above reasons, the machined product M having an excellent machining accuracy can be manufactured.

When the machining is continued, the cutting insert 16 may be repeatedly brought into contact with a different portion of the workpiece W, while the workpiece W is rotated. Although the cutting tool 10 is brought close to the workpiece W in the embodiment of the present disclosure, the cutting tool 10 only needs to be brought relatively close to the workpiece W. Accordingly, the workpiece W may be brought close to the cutting tool 10. In this respect, the same procedure is performed in separating the cutting tool 10 from the workpiece W.

In an embodiment, (1) a cutting tool includes: a holder having a rod shape extending from a front end toward a rear end and including a front end surface located on a side of the front end, an upper surface extending from the front end surface toward the rear end, a lower surface located on an opposite side to the upper surface, a first side surface located between the upper surface and the lower surface and extending from the front end surface toward the rear end, a second side surface located on an opposite side to the first side surface, and a pocket open to the front end surface, the upper surface, and the first side surface; a cutting insert located in the pocket and including a cutting edge; and a sensor unit including a unit base located from the lower surface to the second side surface, including a first recessed portion open toward the lower surface, and a second recessed portion open toward the second side surface, and having an L shape in a cross section orthogonal to a longitudinal direction of the holder, a first sensor located in the first recessed portion, in contact with the lower surface, and configured to detect a physical quantity of the holder; and a second sensor located in the second recessed portion, in contact with the second side surface, and configured to detect a physical quantity of the holder in a detection direction orthogonal to a detection direction of the first sensor.

(2) In the cutting tool according to (1), the unit base may include a third recessed portion open toward the second side surface, and the sensor unit may further include a third sensor located in the third recessed portion, in contact with the second side surface, and configured to detect a physical quantity of the holder in a detection direction orthogonal to the detection directions of the first sensor and the second sensor.

(3) In the cutting tool according to (2), a position of the third sensor in the longitudinal direction may be the same as a position of the second sensor in the longitudinal direction.

(4) In the cutting tool according to any one of (1) to (3), the holder may further include a rear end surface located on an opposite side to the front end surface, and a distance from the unit base to the front end surface in the longitudinal direction may be shorter than a distance from the unit base to the rear end surface in the longitudinal direction.

(5) In the cutting tool according to any one of (1) to (4), the unit base may include a first portion located on the lower surface and a second portion located on the second side surface, and an entirety of the first portion may be located closer to the second side surface than to the first side surface.

(6) In the cutting tool according to any one of (1) to (5), the unit base may include a first portion located on the lower surface and a second portion located on the second side surface, and an entirety of the second portion may be located closer to the lower surface than to the upper surface.

(7) A method for manufacturing a machined product includes rotating a workpiece; bringing the cutting tool according to any one of (1) to (6) into contact with the workpiece that is rotating, and cutting the workpiece; and separating the cutting tool from the workpiece that has been cut.

In the present disclosure, the invention has been described above based on the drawings and embodiments. However, the invention according to the present disclosure is not limited to the above-described embodiment. In other words, the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, note that those skilled in the art can easily make various variations or modifications based on the present disclosure. Note that such variations or modifications are included within the scope of the present disclosure.

### REFERENCE SIGNS

10 Cutting tool
12 Cutting implement rest
12a Placement surface
12b Inner wall surface
12c Fixing screw
14 Holder
14a Front end
14b Rear end
14m Body portion
16 Cutting insert
18 Clamp
20 Clamping screw
22 Front end surface
24 Rear end surface
26 Upper surface
28 Lower surface
30 First side surface
32 Second side surface
34 Pocket
36 First insert surface
38 Second insert surface
40 Insert side surface
42 Cutting edge
44 Through hole
46 Sensor unit
48 Unit base
48a First portion
48b Second portion
50 First recessed portion
52 Second recessed portion
54 Third recessed portion
56 First sensor
58 Second sensor
60 Third sensor
62 Wiring member
64 Groove
66 Wiring conductor

1. A cutting tool comprising:
a holder having a rod shape extending from a front end toward a rear end and comprising:
a front end surface located on a side of the front end;
an upper surface extending from the front end surface toward the rear end;
a lower surface located on an opposite side to the upper surface;
a first side surface located between the upper surface and the lower surface and extending from the front end surface toward the rear end;
a second side surface located on an opposite side to the first side surface; and
a pocket open to the front end surface, the upper surface, and the first side surface;
a cutting insert located in the pocket and comprising a cutting edge; and
a sensor unit comprising:
a unit base located from the lower surface to the second side surface, comprising a first recessed portion open toward the lower surface, and a second recessed portion open toward the second side surface, and having an L shape in a cross section orthogonal to a longitudinal direction of the holder;
a first sensor located in the first recessed portion, in contact with the lower surface, and configured to detect a physical quantity of the holder; and
a second sensor located in the second recessed portion, in contact with the second side surface, and configured to detect a physical quantity of the holder in a detection direction orthogonal to a detection direction of the first sensor.

2. The cutting tool according to claim 1, wherein
the unit base comprises a third recessed portion open toward the second side surface, and
the sensor unit further comprises a third sensor located in the third recessed portion, in contact with the second side surface, and configured to detect a physical quantity of the holder in a detection direction orthogonal to the detection directions of the first sensor and the second sensor.

3. The cutting tool according to claim 2, wherein
a position of the third sensor in the longitudinal direction is the same as a position of the second sensor in the longitudinal direction.

4. The cutting tool according to claim 1, wherein,
the holder further comprises a rear end surface located on an opposite side to the front end surface, and
a distance from the unit base to the front end surface in the longitudinal direction is shorter than a distance from the unit base to the rear end surface in the longitudinal direction.

5. The cutting tool according to claim 1, wherein
the unit base comprises a first portion located on the lower surface and a second portion located on the second side surface, and
an entirety of the first portion is located closer to the second side surface than to the first side surface.

6. The cutting tool according to claim 1, wherein
the unit base comprises a first portion located on the lower surface and a second portion located on the second side surface, and
an entirety of the second portion is located closer to the lower surface than to the upper surface.

7. A method for manufacturing a machined product, the method comprising:
rotating a workpiece;
bringing the cutting tool according to claim 1 into contact with the workpiece that is rotating, and cutting the workpiece; and
separating the cutting tool from the workpiece that has been cut.
